(19) United States
(12) Patent Application Publication
(10) Pub. No.: US 2010/0227024 A1
(43) Pub. Date: Sep. 9, 2010

(54) FORMING ROLLER STRUCTURE FOR DOUGH SHEET PRODUCTS, PERSONALIZED WITH EMBOSSING AND AN OBTAINED PRODUCT

(76) Inventor: Edgar Alonzo Rodriguez Flores, Monterrey (MX)

Correspondence Address: John A. Thomas, 14801 Quorum Drive, Suite 500, Dallas, TX, 75254, US

(21) Appl. No.: 12/617,857

(22) Filed: Nov. 13, 2009

(30) Foreign Application Priority Data
Mar. 5, 2009 (MX) MX/U/20097/000071

(51) Int. Cl. A21C 11/04; A21D 8/00; A21D 13/00

(52) U.S. Cl. 426/87; 425/292; 426/383

(57) ABSTRACT

A forming roller structure for making dough sheet products from a dough sheet has a cylindrical body turned on a axle. The axle preferably has annular bodies of a greater diameter than the axle and gears for holding the roller structure in a tortilla machine and engaging the cylindrical body with the mechanism of the tortilla machine. The cylindrical body has an outer surface with a cutting border formed therein to define the edge of a dough sheet product, such as a tortilla. The outer surface also has embossing located within the cutting border, so that the embossing presses a predetermined design into the dough sheet surface as the dough sheet is moved with respect to the cylindrical body. The design may be text or a graphic image. A dough sheet product with an embossed design and a method of making same are also disclosed.

### CLAIM FOR PRIORITY

This application claims priority under 35 USC §119 to Mexican Utility Model Application Serial No. MX/u/20097/000071, filed on Mar. 5, 2009, the entire contents of which are incorporated by reference.

### BACKGROUND

1. Technical Field

This invention is related to the manufacturing industry of equipment and accessories of tortilla machines for the production of sheet products made from corn, wheat or other type of dough. More specifically, it refers to a forming roller structure for sheet products from a dough base, personalized in a such a way that it allows placing, in a low and/or high embossing, a brand, embossing or seal on at least one its sides.

2. Background

It is well known that mechanical tortilla machines may be configured to feed a certain amount of dough through a hopper that dispenses dough through a lower orifice due to the action of the kneading blades. The dough is pushed through conduction tubes where endless screws are placed and feed the dough. This dough is pushed through the aforementioned small endless screws from a pressure chamber to a set of pressing metallic plates that create a dough sheet with a predetermined thickness, according to the thickness required by desired product (tortilla, nacho, chips, chalupa, tostada, huarache, tlacoyo, or any other sheet product from a dough base). A cutting roller is mounted at the exit point of the dough sheet, and it is triggered by a gear or sprocket and/or pressure exerted by some levers called oscillating arms. These are usually triggered by springs or any other mechanism that exerts pressure or creates a leverage point. This pressure exerted over the cutting roller cuts the sheet product in the required shape, depending on the product being obtained (tortilla, nacho, chips, chalupa, tostada, huarache, tlacoyo, or any other sheet product from a dough base).

The cutting rollers are simple rollers with shaped cutting borders that when turned over the dough sheet, cut the outer border in order to generate the desired dough product's shape.

Also, the finished products made from a laminated sheet of corn, wheat or other grains, and that are currently known and marketed, are produced with both sides substantially smooth, without distinctions or embossing.

Currently, there is no forming roller structure for dough sheet products that allows the application over the product of a print, brand, lettering, logo, image, text, marketing or advertising in a low or high embossing, thus allowing the differentiation, printing and/or personalization of the product during production. There are no known dough sheet products with these characteristics either; therefore, this provides a significant advantage within this industrial field.

This invention's main objective is to make available a forming roller structure for dough laminated products (corn, wheat or other kind of dough) that allows the application, in at least one of their sides, in low or high embossing, of a print, brand, lettering, logo, image, text, marketing or advertising.

Another objective from this invention is to make available such forming roller structure for dough sheet products, personalized with a low or high embossing, that can also be mounted on and removed from a tortilla machine, fulfilling the characteristics of creating a dough film from corn, wheat or any other kind of grain, as long as it is of the molding type and cut with a cutting roller.

Another objective for this invention is to make available such forming roller structure for dough sheet products, personalized with a low or high embossing that also has an engraving in a low and/or high embossing within the limits of the cutting borders that shape the product, with a variable height and depth depending on the dough sheet's thickness.

Another objective for this invention of a forming roller structure for dough sheet products, personalized with a low or high embossing, is to manufacture it from the proper material so that it keeps the dough from sticking during the product's cutting and engraving.

Another objective for this invention is to make available such forming roller structure for dough sheet products, personalized with a low or high embossing that also allows a better demolding of the cut and engraved product.

Another objective for this invention is to make available such forming roller structure for dough sheet products, personalized with a low or high embossing that also allows a more accurate, well defined, cut and engraving of the product.

One more objective for this invention is to make available such forming roller structure for dough sheet products, personalized with a low or high embossing, with a better hygiene, from a food-grade material and that is easier to clean and work with.

Yet another objective for this invention is to make available a food product from a dough sheet base made of corn, wheat or any other grain, that has in at least one of its sides a print, brand, lettering, logo, image, text, marketing or advertising, in a low or high embossing.

And all those characteristics and objectives that will be apparent while providing the general and detailed description of the invention, supported by the modalities presented.

### DRAWINGS

FIG. 1 shows a conventional perspective view of a forming roller for dough sheet products, personalized with a low or high embossing, according to the this invention.

FIG. 2 shows in a conventional perspective a section of the forming roller for dough sheet products, personalized with a low or high embossing, according to the this invention.

FIGS. 3 and 4 show a conventional perspective view of a dough sheet product, personalized with a low or high embossing, according to this invention.

### DESCRIPTION

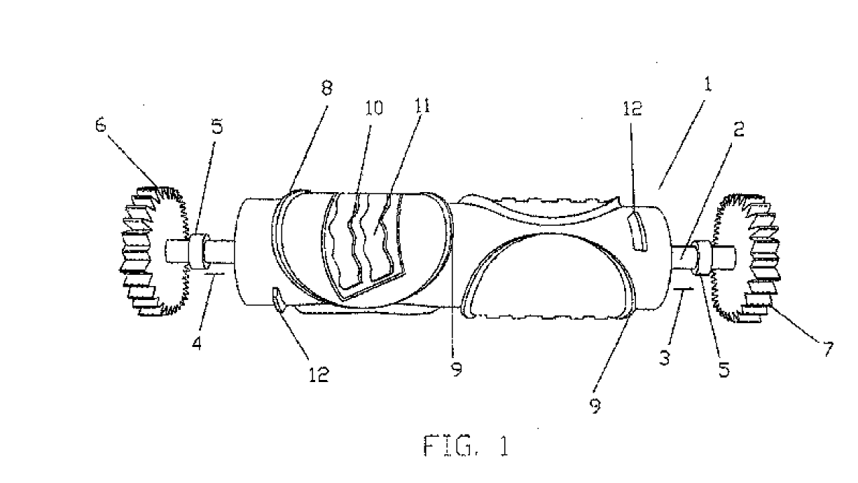

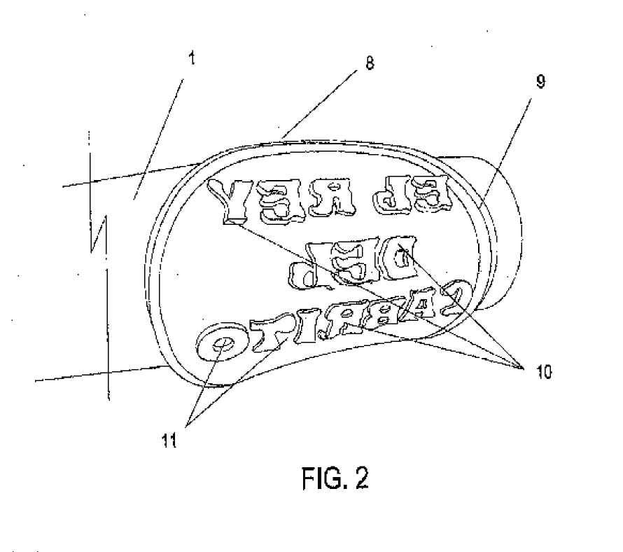

The characteristic details of the forming roller structure for dough sheet products, personalized with a low or high embossing, are clearly shown on the following description and on the attached illustrative drawings, and the same reference signs are used to point out the same parts. As shown by the figures, “embossing” in this application should be understood to mean “engraving” as well as “embossing” in the strict sense, as the designs imparted to the dough sheet products by the disclosed structure may be in both high and low relief Referring to FIGS. 1 and 2, which show a conventional perspective view of a forming roller for dough sheet products, personalized with a low or high embossing, as a whole and from one section, respectively, according to this invention. Based on these figures, the forming roller structure for dough sheet products, personalized with a low or high embossing, comprises a solid cylindrical body 1 preferably made from a plastic material (such as UHMW-PE or Ultra High Molecular Weight-Polyethylene), or it can be made from any plastic material with similar characteristics; with a metal axle 2 cutting through the middle from end to end. This axle 2 is centrally embedded on the aforementioned solid plastic cylinder 1 and it generates two exiting sections 3 and 4 on the sides where annular bodies of a larger diameter 5 than the axle 2 are defined so it can be held in a tortilla machine. The cylindrical body 1 also includes gear elements 6 and 7 to engage with the tortilla machine's pushing mechanism (not shown). Such solid cylindrical body 1 made of a preferably plastic material includes at least an outline 8 on its outer surface that defines a cutting border or sharpened blade 9 that in turn, defines the dough sheet product's shape to be cut (circular, oblong, elliptical, or other shape). Within the outline 8 delimited by such border or sharpened blade 9 there are borders 10 that protrude over the surface and/or valleys or grooves 11 all the way to the outer surface limit or deeper than the roller's outer surface 1, in a predetermined arrangement defined by texts and/or graphics in a low and/or high embossing that will be applied on the dough sheet product in order to generate a print, brand, lettering, logo, image, text, marketing or advertising, which will allow to differentiate, print and/or personalize the product during its production.

The solid cylindrical body 1 also incorporates, near its outer surface ends, side cutting blades 12 that cut excess dough from the rollers' ends in order to ease the product's demolding or release with the given shape.

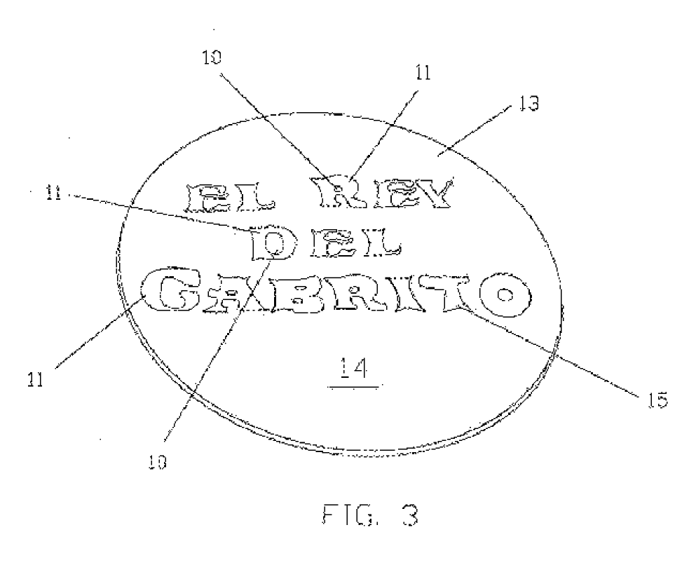

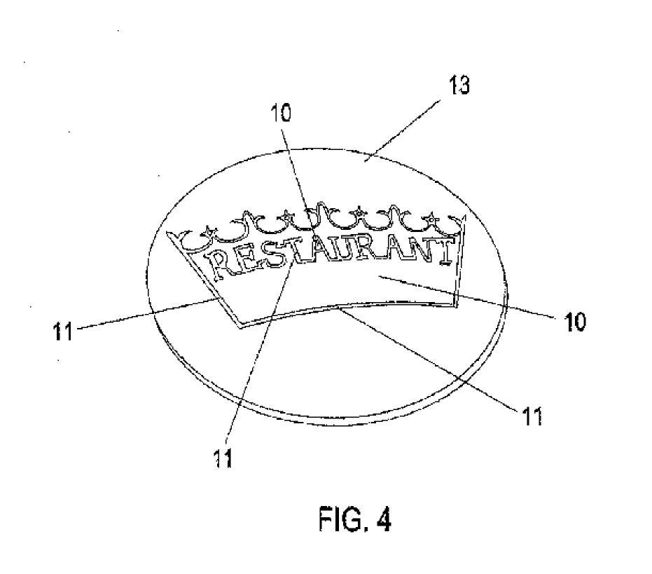

Referring to FIGS. 3 and 4, they show a conventional perspective view of a dough sheet product, personalized in a low or high embossing, according to this invention. The finished product 13 can be seen on these figures, (in this case, a corn tortilla), which is a dough sheet product made from corn flour; however, it may be manufactured with other kinds of grain flour. Such product includes, in at least one of its faces 14, a low and/or high embossing 15 resulting from the border 10 that protrude from the surface and/or valleys or grooves 11 all the way to the outer surface border, or deeper than the roller's outer surface 1, that defines a print, sign, brand, lettering, logo, image, text, marketing or advertising, as a distinction and personalization that sets it apart from the standard techniques.

This way, we obtain a finished product that may be fried, cooked, raw, pre-cooked, dehydrated, processed, pressed, mixed, multi-grain, homemade, industrial, spicy, seasoned, with added vitamins, mineralized, with sprouts, with vegetables, with fruits, flavored, colored, with essences, mixed with meat products, low-calorie products, diet products, organic, etc. and they may be packed, wrapped, etc. with the aforementioned characteristics.

The invention has been sufficiently described so that a person with average knowledge on this field may be able to reproduce and obtain the results mentioned on this invention. However, any person with skills on the technical field related to this invention may be able to make modifications not mentioned on this application; however, if the application of these modifications to a given structure, or during its manufacturing process, requires the use of specifications included on the following claims, such structures must be included within the invention's scope.

I claim:

1. A forming roller structure for making dough sheet products from a dough sheet comprising:
a cylindrical body;
the cylindrical body having a axle;
the axle having annular bodies of a diameter greater than the diameter of the axle, for holding the roller structure in a tortilla machine;
the axle further having at least one gear for engagement with the mechanism of the tortilla machine;
the cylindrical body having an outer surface;
the outer surface of the cylindrical body comprises a cutting border, where the cutting border defines the edge of the dough sheet product;
the outer surface comprisng embossing located within the cutting border, so that the embossing presses a predetermined design into the dough sheet as the dough sheet is moved with respect to the cylindrical body.

2. The forming roller structure of claim 1 where the predetermined design comprises text.

3. The forming roller structure of claim 1 where the predetermined design comprises an image.

4. The forming roller structure of claim 1, where the cylindrical body further comprises:
a first side cutting blade located at one end of the cylindrical body, and a second side cutting blade located at the opposite end of the cylindrical body,
so that the side cutting blades remove excess dough from the roller structure as the dough sheet is moved with respect to the cylindrical body.

5. The forming roller structure of claim 1, where the cylindrical roller is made of a plastic.

6. A dough sheet food product comprising:
a dough sheet having edges cut to a predetermined shape;
a predetermined design embossed into the surface of the dough sheet product by passing the dough sheet product over a forming roller structure.

7. The dough sheet product of claim 6 where the predetermined design comprises text.

8. The dough sheet product of claim 6 where the predetermined design comprises an image.

9. The dough sheet product of claim 6, where the predetermined shape is that of a tortilla.

10. A method for making a dough sheet product having a predetermined embossed design, the method comprising:
passing a dough sheet over a cylindrical roller having a predetermined embossed design on its outer surface; and,
simultaneously:
embossing the predetermined design into the dough sheet;
defining the edge of the dough sheet product; and,
removing excess dough from the cylindrical roller with side cutting blades attached to the cylindrical roller.
